(19) United States
(12) Patent Application Publication
(10) Pub. No.: US 2017/0091788 A1
(43) Pub. Date: Mar. 30, 2017

(54) METHODS AND APPARATUS FOR ANALYZING VISITOR SPENDING BEHAVIOR

(71) Applicant: MasterCard International Incorporated, Purchase, NY (US)

(72) Inventors: Rakesh Kumar Tiwari, Dwarka (IN); Abishek Gautam, Delhi (IN); Shashank Kumar Trivedi, Dwarka (IN)

(21) Appl. No.: 15/274,000

(22) Filed: Sep. 23, 2016

(30) Foreign Application Priority Data
Sep. 25, 2015 (SG) 10201507975P

(51) Int. Cl. G06Q 30/02; G06Q 20/34; H04W 4/02

(52) U.S. Cl. CPC G06Q 30/0201; H04W 4/02; G06Q 20/341

(57) ABSTRACT

A method of analyzing the behavior of visitors to an area is provided. The method includes receiving transaction data for visitors to the area, the transaction data includes transactions by the visitors to the area and merchant locations within the area where the transactions occurred. The method further includes receiving telecom network user data for visitors to the area, the telecom network user data including locations of mobile communication devices of visitors to the area. The method also includes combining the transaction data for visitors to the area and the telecom network user data by matching the locations of mobile communication devices of the visitors to the area with the merchant locations within the area to obtain combined visitor data, and analyzing the behavior of visitors to the area using the combined visitor data.

### CROSS REFERENCE TO RELATED APPLICATIONS

This application claims the benefit of Singapore Patent Application No. 10201507975P filed Sep. 25, 2015, which is hereby incorporated by reference in its entirety.

### BACKGROUND

The present disclosure relates to a method and system for processing data. In particular, it provides a method and system for processing data to analyze the spending behavior of visitors to an area.

Including direct, indirect and induced impact, Tourism in the World contributes 9% of GDP and provides 1 in 11 jobs in the World (according to the United Nations World Tourism Organization (UNWTO) 2015 report). It is one of the key drivers of development. Spending by visitors to an area provides many merchants such as retailers with an important part of their revenue. Specific groups of visitors, for example, visitors from particular countries or regions or particular demographic groups may be potentially of specific importance to certain merchants. An understanding of the spending behavior of visitors to an area allows merchants to target and optimize marketing, such as advertising and promotional offers to visitors to maximize sales and revenues.

### BRIEF DESCRIPTION

In general terms, the present disclosure proposes a method and apparatus for analyzing visitor spending behavior. In the proposed method and system, transaction data for visitors is combined with data for visitors from a telecommunications network. The combination of telecommunications network data with the transaction data allows the visitors' behavior to be analyzed in detail. This in turn provides merchants with information which can be used to target marketing to visitors.

According to a first aspect, a computer implemented method of analyzing the behavior of visitors to an area is provided. The method includes receiving, at a server of a data processing system, transaction data for visitors to the area, the transaction data including indications of transactions by the visitors to the area and indications of merchant locations within the area corresponding to the transactions, receiving, at the server of the data processing system, telecom network user data for visitors to the area, the telecom network user data including indications of locations of mobile communication devices of visitors to the area, combining the transaction data for visitors to the area and the telecom network user data by matching the locations of mobile communication devices of the visitors to the area with the merchant locations within the area to obtain combined visitor data, and analyzing the behavior of visitors to the area using the combined visitor data.

In an embodiment, the indications of locations of the merchants within the area include indications of postcodes of the merchants, and wherein matching the locations of mobile communication devices of the visitors to the area with the merchant locations within the area includes determining locations corresponding to the postcodes of the merchants.

In an embodiment, determining locations corresponding to the postcodes of the merchants includes looking up latitude and longitude coordinates corresponding to the postcodes in a database.

In an embodiment, the method further includes segmenting general transaction data to determine the transaction data for visitors to the area. This segmentation may include segmenting the general transaction data based on a country in which a payment card associated with transactions was issued.

In an embodiment, the method further includes segmenting general telecom network user data to determine the telecom network user data for visitors to the area. This segmentation may include identifying users of the telecom network with mobile devices registered with a telecom network outside the area.

The transaction data may be anonymized transaction data.

In an embodiment, the telecom network user data further includes demographic data.

In an embodiment, analyzing the behavior of visitors to the area includes determining an indication of market share for a merchant within the area.

In an embodiment, analyzing the behavior of visitors to the area further includes segmenting the visitors into a plurality of visitor segments and determining an indication of market share for each visitor segment. The visitor segments may be countries and/or regions of origin for the visitors.

According to a second aspect, an apparatus for analyzing the behavior of visitors to an area is provided. The apparatus includes a computer processor and a data storage device, the data storage device having a matching module and an analysis module including non-transitory instructions that, when executed, cause the processor to receive transaction data for visitors to the area, the transaction data comprising indications of transactions by the visitors to the area and indications of merchant locations within the area corresponding to the transactions, receive telecom network user data for visitors to the area, the telecom network user data including indications of locations of mobile communication devices of visitors to the area, combine the transaction data for visitors to the area and the telecom network user data by matching the locations of mobile communication devices of the visitors to the area with the merchant locations within the area to obtain combined visitor data, and analyze the behavior of visitors to the area using the combined visitor data.

According to a third aspect, a non-transitory computer-readable medium is provided. The computer-readable medium has stored thereon program instructions for causing at least one processor to perform operations of the method disclosed above.

### BRIEF DESCRIPTION OF THE DRAWINGS

Embodiments of the disclosure will now be described for the sake of non-limiting example only, with reference to the following drawings in which:

FIG. 1 schematically illustrates an area where the behavior of visitors may be analyzed using the methods and systems according to embodiments of the present invention;

FIG. 2 illustrates locations of visitors to the area shown in FIG. 1;

FIG. 3 is a block diagram of a data processing system according to an embodiment of the present disclosure;

FIG. 4 is a block diagram illustrating a technical architecture of the apparatus according to an embodiment of the present disclosure; and

FIG. 5 is a flowchart illustrating a method of analyzing the behavior of visitors to an area according to an embodiment of the present disclosure.

### DETAILED DESCRIPTION

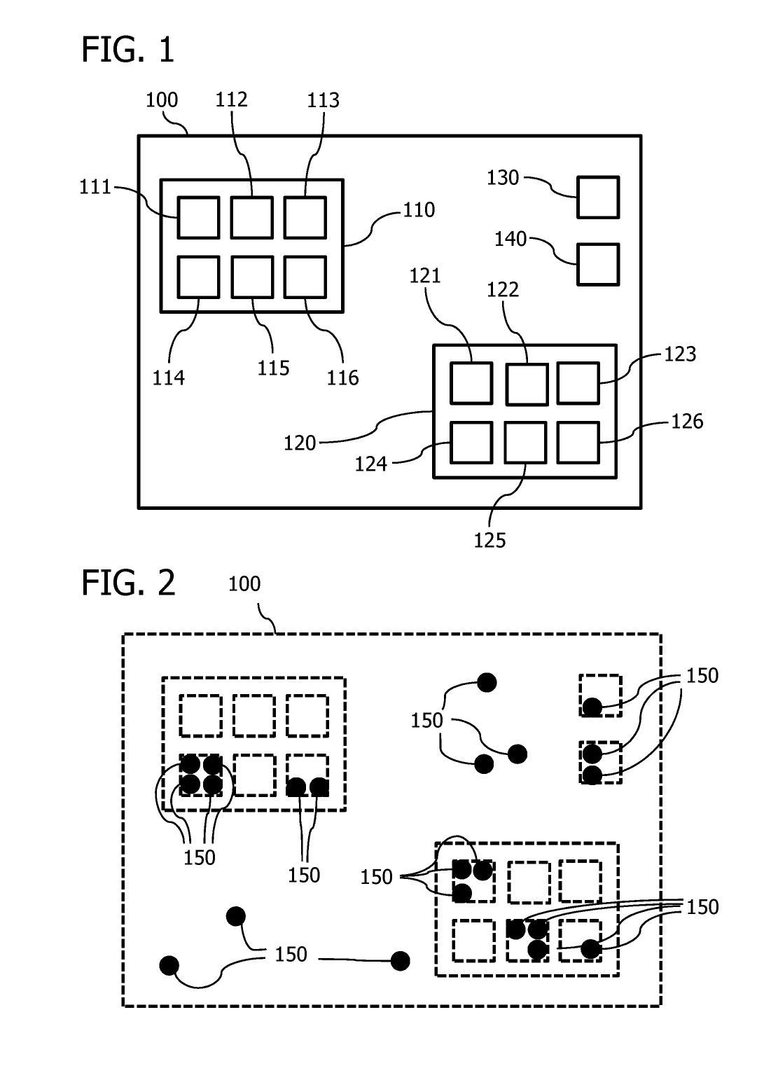

FIG. 1 schematically illustrates an area where the behavior of visitors may be analyzed using the methods and systems according to embodiments of the present disclosure. The area 100 includes a first shopping mall 110 which includes six merchants 111-116. The area 100 further includes a second shopping mall 120 which includes six merchants 121-126. The area 100 includes two further merchants 130 and 140 which are not part of either of the first shopping mall 110 or the second shopping mall 120. The merchants may be retailers, restaurants, or other service providers. Each of the merchants is connected to a payment network which processes payment card transactions. The payment network can be any electronic payment network which connects, directly and/or indirectly payers (consumers and/or their banks or similar financial institutions) with payees (the merchants and/or their banks or similar financial institutions). A non-limiting example of the payment network is a payment card type of network, such as the payment processing network operated by MasterCard, Inc. The various communications may take place via any type of network, for example, virtual private network (VPN), the Internet, a local area and/or wide area network (LAN and/or WAN), and so on.

FIG. 2 shows locations mobile devices of visitors to the area shown in FIG. 1. The locations 150 of the mobile devices visitors to the area 100 are determined by a telecommunications network provider. The locations 150 of the visitors may be determined by analyzing signals received by base stations of the telecommunications network to locate the mobile device within a cell of the telecommunications network.

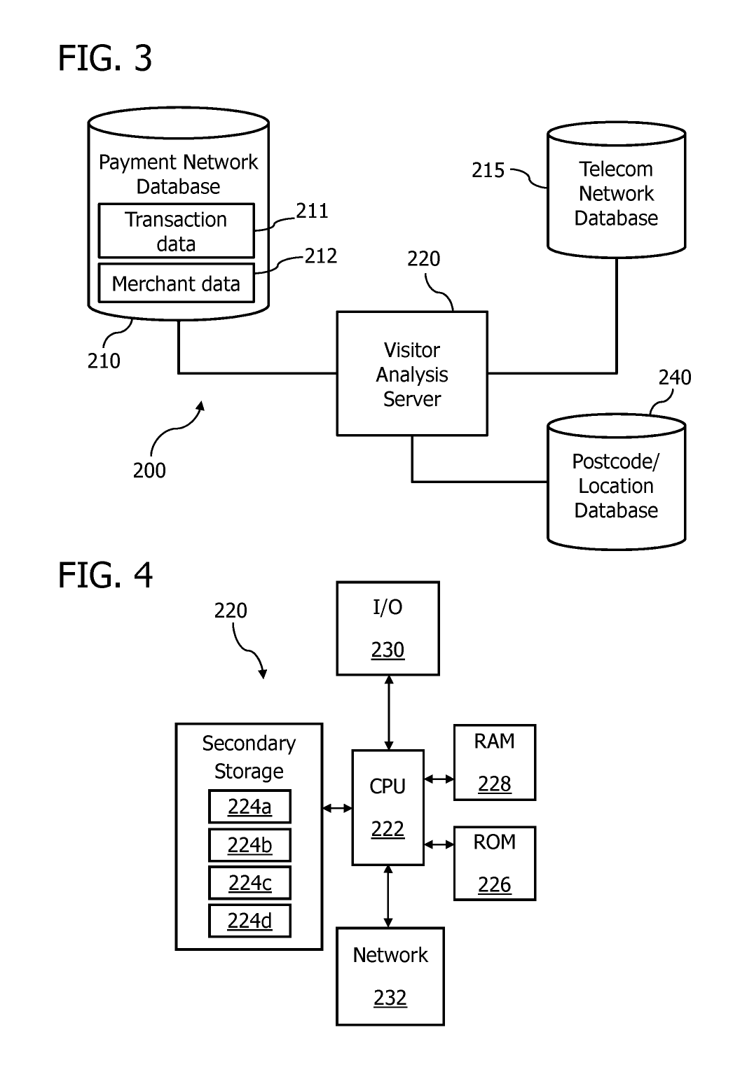

FIG. 3 shows a data processing system according to an embodiment of the present disclosure. The data processing system 200 includes a visitor analysis server 220. The visitor analysis server 220 is coupled to a payment network database 210, a telecom network database 215 and a postcode location database 240.

The payment network database 210 stores transaction data indicating details of transactions carried out at the merchants shown in FIG. 1. The payment network database 210 stores transaction data 211 and merchant data 212. The transaction data 211 is stored in transaction tables that include transaction related variables such as transaction amount, count, and merchant category. The merchant data 212 is stored in merchant location tables which include merchant post code, name, address, and city.

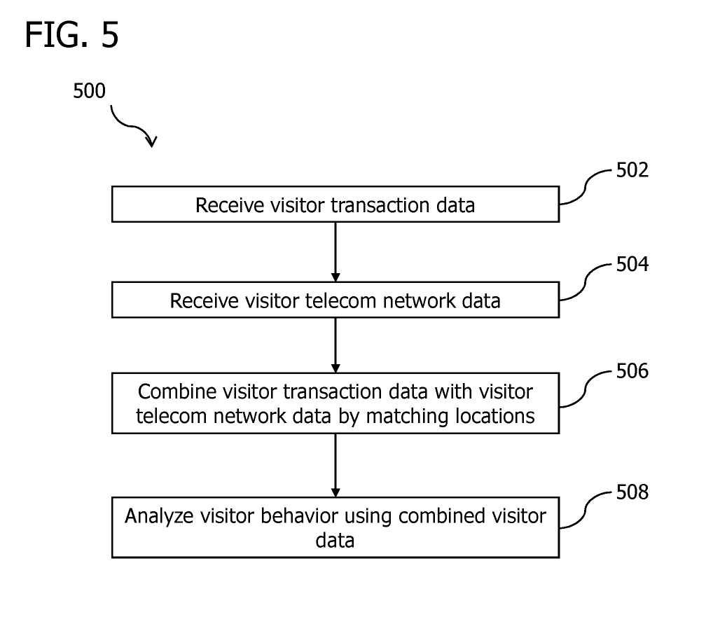

FIG. 4 is a block diagram showing a technical architecture of the server of the payment network data warehouse 150 for performing an exemplary method 500 which is described below with reference to FIG. 5. Typically, the method 500 is implemented by a computer having a data-processing unit. The block diagram, as shown in FIG. 4, illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 220 may further include input/output (I/O) devices 230, and network connectivity devices 232.

The secondary storage 224 typically includes one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a transaction data segmentation component 224a, a telecom network data segmentation component 224b, a matching component 224c, and an analysis component 224d including non-transitory instructions that, when executed, cause the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may provide computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 500 will now be described with reference to FIG. 5 in respect of analysis of transactions involving a merchant to provide key performance indicator and also an analysis of market data to provide relative market indicators. It should be noted that enumeration of operations is for purposes of clarity and that the operations need not be performed in the order implied by the enumeration.

In step 502, the visitor analysis server 220 receives visitor transaction data from the payment network database 210. The visitor transaction data includes details of transactions by visitors and details of the merchants where the transactions were carried out. The details of the merchants may include the merchant location which may be indicated by a postcode. The merchant details may also include indications of the category or type of merchant.

In an embodiment, in step 502, the visitor analysis server 220 receives general transaction data, which includes visitor transaction data and transaction data for other individuals, for example, those who permanently live in the area. In this case, the transaction data segmentation component 224a of the visitor analysis server 220 segments the general transaction data to provide the visitor transaction data.

The segmentation by the transaction data segmentation component 224a may take place in a number of different ways. In one embodiment, the transaction data segmentation component 224a identifies visitors to the area by analyzing transactions over a period of time. Visitors to the area are identified by the locations of transactions, for example, if a cardholder makes transactions in the area for a short period of time, for example, one week, then they are identified as a visitor. Certain transactions, such as those at a hotel, may also be used to identify visitors. Additionally, or alternatively, cardholder data, such as address data, may be used to identify visitors to the area. In an embodiment, visitors to the area may be identified as cardholders of payment cards issued by foreign banks or card issuers. It is noted here that the cardholder details may be anonymized, that is any information that can be used to identify the cardholder may be removed, therefore, visitors from another region of the same country may be identified based on card spend behavior or transaction profile.

In step 504, the visitor analysis server 220 receives visitor telecom network data. The visitor telecom network data includes indications of locations visited by mobile device users. These locations may take the form of a grid reference indicating the latitude and longitude of the location of the mobile device. The location information may also include time information. In addition to the location information, the visitor telecom network data may also include information on the user of the mobile device. This information may include details of the country and/or area of origin of the user. The country of the user may be determined by the country code of the telephone number of the mobile device. Additional information, such as the area of origin, may be determined from details provided to the telecom network during user registration, such as demographic details.

In an embodiment, in step 504, the visitor analysis server 220 receives general telecom network data, which includes visitor telecom network data and telecom network data for other individuals, for example, those who permanently live in the area. In this case, the telecom data segmentation component 224b of the visitor analysis server 220 segments the general telecom network data to provide the visitor telecom network data.

The segmentation by the telecom data segmentation component 224b may take place in a number of different ways. As described above, the telecom network data may include country information from the country code of the telephone number of each mobile device. The telecom data segmentation component 224b may use area of origin data provided during user registration to segment the visitor telecom network data from the general telecom network data. In one embodiment, visitors to the area from other countries may be identified as those using the telecom network for ‘roaming’. That is mobile devices which are operating in an area outside their home network.

In step 506, the combination component 224c of the visitor analysis server 220 combines the visitor transaction data with the visitor telecom network data by matching the locations of the merchants corresponding to the transactions with the locations of the visitors' mobile devices.

In one embodiment, the merchant locations in the visitor transaction data include the postcodes of the merchants. In order to combine these merchant locations with the locations in the visitor telecom data which may include, for example, latitude and longitude coordinates, the combination component 224c may use the postcode/location database 240 to determine latitude and longitude coordinates corresponding to the postcodes. This allows the locations of the mobile devices of the visitors to be compared with the locations of the merchants.

In step 508, the analysis component 224d of the visitor analysis server 220 analyses the combined visitor data. The analysis in step 508 may be provided to one of the merchants, for example, a merchant 114 within the first shopping mall 110. The analysis may indicate the number of tourists or visitors to the area that enter the merchant's premises compared to the spend by those tourists in the merchant. The analysis may be focused on tourists from a particular location such as a country or region.

In one embodiment, the analysis provides an indication of the market share of a merchant compared to the number of visitors entering the merchant. This allows the merchant to identify possible marketing opportunities, if for example, there is a relatively large number of visitors from a particular region or country, but the spend by those visitors is low.

The analysis step 508 may include identifying opportunity segments for merchants such as retailers. This information may be used by the retailers to assist in execution of their marketing programs and show incremental sales/ROI. The analysis step 508 may involve identification of target consumer segments and the locations of the target consumer segments.

In an embodiment, the analysis step 508 includes determining a market share for a retailer by comparing spending a segment of tourists in that retailer with the sending of that segment of tourists at other retailers. The segmenting of tourist may be by country or region of origin.

For example, a retailer observes that Indians shopping at its shop are almost half of their spend with similar retailers in that area and visits are almost similar to other stores. As part of the analysis, it can be identified which segment of Indians i.e. South, North, or West are spending less at the merchant. This information can then be used in mass marketing campaigns of that retailer through channels such as Email, and Mail.

The analysis in step 508 may be provided to a shopping mall and/or high end retailer which are key destinations for visitors coming from different countries. In which case, the analysis may indicate the spend inside the shopping mall compared to the spend outside the shopping mall or with other shopping malls for that location for a group of visitors compared to the number of visitors from that group.

Whilst the foregoing description has described exemplary embodiments, it will be understood by those skilled in the art that many variations of the embodiment can be made within the scope and spirit of the present disclosure.

1. A computer implemented method of analyzing the behavior of visitors to an area, the method comprising:
receiving, at a server of a data processing system, transaction data for visitors to the area, the transaction data comprising indications of transactions by the visitors to the area and indications of merchant locations within the area corresponding to the transactions;
receiving, at the server of the data processing system, telecom network user data for visitors to the area, the telecom network user data comprising indications of locations of mobile communication devices of visitors to the area;
combining the transaction data for visitors to the area and the telecom network user data by matching the locations of mobile communication devices of the visitors to the area with the merchant locations within the area to obtain combined visitor data; and
analyzing the behavior of visitors to the area using the combined visitor data.

2. A method according to claim 1, wherein the indications of locations of the merchants within the area comprise indications of postcodes of the merchants, and wherein matching the locations of mobile communication devices of the visitors to the area with the merchant locations within the area comprises determining locations corresponding to the postcodes of the merchants.

3. A method according to claim 2, wherein determining locations corresponding to the postcodes of the merchants comprises retrieving latitude and longitude coordinates corresponding to the postcodes from a database.

4. A method according to claim 1, further comprising segmenting general transaction data to determine the transaction data for visitors to the area.

5. A method according to claim 4, wherein segmenting general transaction data to determine the transaction data for visitors to the area comprises segmenting the general transaction data based on a country in which a payment card associated with transactions was issued.

6. A method according to claim 1, further comprising segmenting general telecom network user data to determine the telecom network user data for visitors to the area.

7. A method according to claim 6, wherein segmenting general telecom network user data to determine the telecom network user data for visitors to the area comprises identifying users of the telecom network with mobile devices registered with a telecom network outside the area.

8. A method according to claim 1, wherein the transaction data is anonymized transaction data.

9. A method according to claim 1, wherein the telecom network user data further comprises demographic data.

10. A method according to claim 1, wherein analyzing the behavior of visitors to the area comprises determining an indication of market share for a merchant within the area.

11. A method according to claim 10, further comprising segmenting the visitors into a plurality of visitor segments and determining an indication of market share for each visitor segment.

12. A method according to claim 11, wherein the visitor segments are countries and/or regions of origin for the visitors.

13. A non-transitory computer readable medium having stored thereon program instructions for causing at least one processor to perform a method according to claim 1.

14. An apparatus for analyzing the behavior of visitors to an area, the apparatus comprising:
a computer processor and a data storage device, the data storage device having a matching module and an analysis module comprising non-transitory instructions that, when executed, cause the processor to:
receive transaction data for visitors to the area, the transaction data comprising indications of transactions by the visitors to the area and indications of merchant locations within the area corresponding to the transactions;
receive telecom network user data for visitors to the area, the telecom network user data comprising indications of locations of mobile communication devices of visitors to the area;
combine the transaction data for visitors to the area and the telecom network user data by matching the locations of mobile communication devices of the visitors to the area with the merchant locations within the area to obtain combined visitor data; and
analyze the behavior of visitors to the area using the combined visitor data.

15. An apparatus according to claim 14, wherein the indications of locations of the merchants within the area comprise indications of postcodes of the merchants, and wherein matching the locations of mobile communication devices of the visitors to the area with the merchant locations within the area comprises determining locations corresponding to the postcodes of the merchants.

16. An apparatus according to claim 15, wherein determining locations corresponding to the postcodes of the merchants comprises retrieving latitude and longitude coordinates corresponding to the postcodes from a database.

17. An apparatus according to claim 14, the data storage device further comprising a transaction data segmentation module comprising non-transitory instructions by that, when executed, cause the processor to segment general transaction data to determine the transaction data for visitors to the area.

18. An apparatus according to claim 17, wherein the transaction data segmentation module further comprises non-transitory instructions that, when executed, cause the processor to segment the general transaction data based on a country in which a payment card associated with transactions was issued.

19. An apparatus according to claim 14, the data storage device further comprising a telecom network data segmentation module comprising non-transitory instructions that, when executed, cause the processor to segment general telecom network user data to determine the telecom network user data for visitors to the area.

20. An apparatus according to claim 19, wherein the telecom network data segmentation module further comprises non-transitory instructions that, when executed, cause the processor to identify users of the telecom network with mobile devices registered with a telecom network outside the area.

21. An apparatus according to claim 14, wherein the transaction data is anonymized transaction data.

22. An apparatus according to claim 14, wherein the telecom network user data further comprises demographic data.

23. An apparatus according to claim 14, wherein the analysis module further comprises non-transitory instructions that, when executed, cause the processor to determine an indication of market share for a merchant within the area.

24. An apparatus according to claim 23, wherein the analysis module further comprises non-transitory instructions that, when executes, cause the processor to segment the visitors into a plurality of visitor segments and determine an indication of market share for each visitor segment.

25. An apparatus according to claim 24, wherein the visitor segments are countries and/or regions of origin for the visitors.
